(19) United States
(12) Patent Application Publication
(10) Pub. No.: US 2018/0312743 A1
(43) Pub. Date: Nov. 1, 2018

(54) GEL HYDRATION UNITS WITH PNEUMATIC AND MECHANICAL SYSTEMS TO REDUCE CHANNELING OF VISCOUS FLUID

(71) Applicant: Halliburton Energy Services, Inc., Houston, TX (US)

(72) Inventor: Max L. Phillippi, Duncan, OK (US)

(21) Appl. No.: 15/771,877

(22) PCT Filed: Dec. 31, 2015
(86) PCT No.: PCT/US2015/068235

§ 371 Date: Apr. 27, 2018

(51) Int. Cl. C09K 8/68; E21B 43/26

(52) U.S. Cl. CPC C09K 8/68; E21B 43/26

(57) ABSTRACT

Systems and methods using certain gel hydration units for preparing gelled treatment fluids for use in subterranean operations are provided. In some embodiments, the gel hydration unit comprises: a body defining an interior space configured to contain a hydrated polymer gel; a plurality of over-under weirs installed in the interior space of the gel hydration unit; and a pneumatic air injection subsystem that is configured to inject gas into the interior space of the gel hydration unit.

### BACKGROUND

The present disclosure relates to systems and methods for preparing gelled treatment fluids for use in subterranean operations.

Treatment fluids can be used in a variety of subterranean treatment operations. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid. Illustrative treatment operations can include, for example, fracturing operations, gravel packing operations, acidizing operations, scale dissolution and removal, consolidation operations, and the like. In hydraulic fracturing operations, a viscous treatment fluid (e.g., a “fracturing fluid”) is typically pumped at high pressures down into a wellbore to fracture the formation and force fracturing fluid into created fractures in order to enhance or increase the production of oil and gas hydrocarbons from wells bored into subterranean formations. The fracturing fluid is also commonly used to carry sand and other types of particles, called proppants, to hold the fracture open when the pressure is relieved. The fractures, held open by the proppants, provide additional paths for the oil or gas to reach the wellbore, which increases production from the well.

Maintaining sufficient viscosity in the treatment fluids used in these operations is important for a number of reasons, including but not limited to control of fluid loss into the formation, effective suspension and transport of proppants, and the like. In some instances, various polymeric gelling agents have been added to water-based drilling fluids to viscosify these treatment fluids and form gels. Gels for well fracturing operations have traditionally been produced using a process wherein a dry gel and a liquid, such as water, are combined in a single operation. However, the gel mixture requires considerable time to hydrate prior to being introduced into a well in order to provide a treatment fluid of the desired viscosity. Thus, the gel and liquid are typically combined in a large hydration unit or tank at the well site where the gel mixture is permitted to hydrate before it is introduced into the well bore.

### BRIEF DESCRIPTION OF THE FIGURES

These drawings illustrate certain aspects of some of the embodiments of the present disclosure, and should not be used to limit or define the disclosure.

FIG. 1 is a schematic view illustrating certain embodiments of systems of the present disclosure for preparing and using a treatment fluid comprising a hydrated gel in a subterranean treatment in a well bore.

FIG. 2 is a drawing illustrating certain embodiments of mobile systems of the present disclosure for preparing and/or using a hydrated gel.

FIG. 3 is a drawing illustrating a gel hydration unit according to certain embodiments of the present disclosure.

FIGS. 4A, 4B, and 5-7 are plots showing data from tests of various different gel hydration units.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

The present disclosure relates to systems and methods for preparing gelled treatment fluids for use in subterranean operations.

More specifically, the present disclosure provides systems and methods incorporating certain hydration units that utilize a pneumatic air injection subsystem and a plurality of over-under weirs to manage the movement of fluid through the hydration unit. Typical hydration units used in the art are designed with the purpose of allowing a polymer gel concentrate to remain in the hydration unit for a sufficient time (due to the size of the unit and the rate of fluid flow therethrough) to allow the gel concentrate to hydrate and thus viscosify to a desired level. It has been discovered that, during the mixing and hydration process, portions of gel in a hydration unit having a lower viscosity (e.g., portions having shorter residence times in the unit), while initially residing farther away from the outlet of the unit, will form “channels” or “rat holes” through portions of the gel in the unit of higher viscosity (e.g., portions having longer residence times in the unit), allowing the lower viscosity gel to shortcut the majority of the holding volume of the unit without sufficient residence time to fully viscosify. This may cause the hydration unit to deliver a lower-viscosity gel than expected or needed for an operation while undesirably retaining more fully hydrated portions of the gel having a higher viscosity. In order to produce a gel of the desired viscosity, excess amounts of gelling agents (in some cases, an excess of approximately 2 pounds per thousand gallons of treatment fluid, and in other cases, much higher concentrations) may be needed. In some instances, the more fully hydrated portions of the gel may finally exit the hydration unit near the end of the stage, resulting in a sharp increase in the viscosity of the gel produced near the end of a pumping cycle. These wide variations in viscosity levels may complicate the production and/or use of the gel in certain subterranean operations.

The methods and systems of the present disclosure incorporate both a pneumatic air injection subsystem and over-under weirs in the hydration unit to alter the flow of fluid therein such that any channels of lower viscosity gel through higher viscosity portions of the gel may be sufficiently disrupted such that the hydrated polymer gel exiting the hydration unit (which may comprise a hydrated polymer gel concentrate or other gelled fluid (e.g., a completed gelled fluid)) has the expected or desired level of hydration and viscosity at a relatively constant level for the entire volume or stage of the gel. In certain embodiments, the systems of the present disclosure may cause a hydrated polymer gel or hydrated polymer gel concentrate to have a residence time in the hydration unit of at least about 90% of its expected residence time (which may be calculated as total volume of the hydration unit divided by the rate at which gel concentrate and aqueous fluid is pumped into the unit). As used herein, the term “polymer gel concentrate” or variations thereof does not require any particular level of concentration, but simply refers to a portion of a gelled fluid that may be combined with or diluted in another fluid to create another fluid of a lower polymer gel concentration.

Among the many potential advantages to the methods and compositions of the present disclosure, only some of which are alluded to herein, the methods, compositions, and systems of the present disclosure may facilitate the more efficient and effective hydration of gelling agents in viscosified fluids, which may reduce the amount of gelling agent needed to produce fluids of the desired or required viscosity. The methods and systems of the present disclosure also may require less energy than those using typical components of conventional hydration units (e.g., mechanical agitators, etc.). Each of these benefits and others may reduce the overall cost needed to provide viscosified fluids for well treatments.

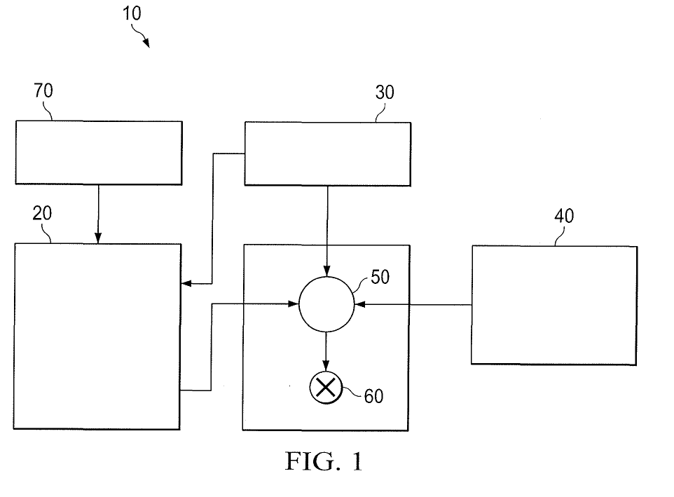

FIG. 1 is one example of a system 10 adapted to hydrate a dry gel for use in fracture stimulating a subterranean zone. The system 10 includes a hydrated gel producing apparatus 20, a liquid source 30, a proppant source 40, and a blender apparatus 50 and resides at a surface well site. The hydrated gel producing apparatus 20 combines dry gel with liquid, for example from liquid source 30, to produce a hydrated gel. In certain implementations, the hydrated gel can be a gel for ready use in fracture stimulation or a gel concentrate to which additional liquid is added prior to use in fracture stimulation. Although referred to as “hydrated,” the hydrating fluid need not be water. For example, the hydrating fluid can include a water solution (containing water and one or more other elements or compounds) or another liquid. In some of the embodiments described herein, the blender apparatus 50 receives the gel for ready use in fracture stimulation and combines it with other components, often including proppant from the proppant source 40. In other instances, the blender apparatus 50 receives the gel concentrate and combines it with additional hydration fluid, for example from liquid source 30, and other components often including proppant from the proppant source 40. In either instance, the mixture may be injected down the wellbore under pressure to fracture stimulate a subterranean zone, for example to enhance production of resources from the zone. The system may also include various other additives 70 to alter the properties of the mixture. For example, the other additives 70 can be selected to reduce or eliminate the mixture's reaction to the geological formation in which the well is formed and/or serve other functions. Although the additives 70 are illustrated as provided from a separate source, the additives 70 may be integrally associated with the apparatus 20.

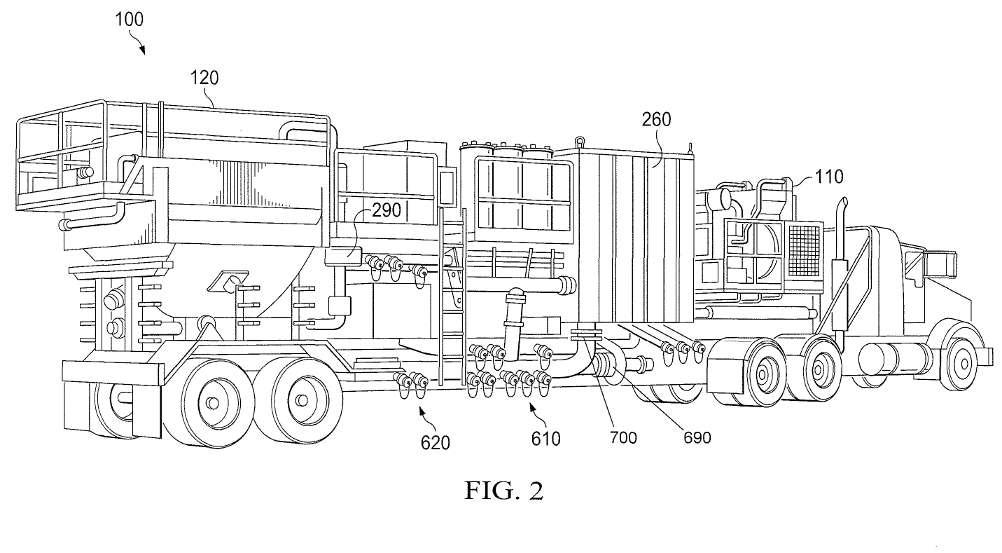

FIG. 2 illustrates an implementation of the apparatus 20 in FIG. 1 for producing the gel concentrate and hydrated gel. Referring now to FIG. 2, the hydrated gel producing apparatus 100 is portable, such as by being included on or constructed as a trailer transportable by a truck. The apparatus 100 may include a bulk material tank 120, a hydration tank 260, and a power source 110. Other features (e.g., a control station) may also be included. Alternatively, the apparatus 20 of FIG. 1 and the components thereof may simply be provided and/or installed on the ground at a well site.

According to one implementation, the power source 110 may be a diesel engine, such as a Caterpillar® C-13 diesel engine, including a clutch. However, the present description is not so limited, and any engine or other power source capable of providing power to the apparatus 100 may be utilized. The power source may also include hydraulic pumps, a radiator assembly, hydraulic coolers, hydraulic reservoir, battery, clutch, gearbox (e.g., a multi-pad gearbox with an increaser), maintenance access platforms, battery box, and one or more storage compartments. Although not specifically illustrated, these features would be readily understood by those skilled in the art. The power source 110 provides, entirely or in part, power for the operation of the apparatus 100. A control station (not shown) on apparatus 100 may provide for control of the various functions performed by the apparatus 100 and may be operable by a person, configured for automated control, or both. The control station may, for example, control an amount of dry gel and liquid combined in a gel mixer (discussed below), the rate at which the gel mixer operates, an amount of gel concentrate maintained in a hydration tank (discussed below), and a gel concentrate output rate. The control station may also control an amount of dry gel dispensed from a bulk-metering tank (discussed below) as well as monitor an amount of dry gel remaining in the bulk-metering tank. Further, the control station may be operable to monitor or control any aspect of the apparatus 100. The apparatus 100 may also include various pumps, such as liquid additive pumps, suction pumps, and concentrate pumps; mixers; control valves; sample ports; flow meters, such as magnetic flow meters; conveying devices; and inventory and calibration load cells.

A hydrated gel producing apparatus (which may be similar to apparatus 20 and/or apparatus 100 as described above) according to certain embodiments of the present disclosure may comprise various components. In addition to a hydration tank of the present disclosure, a hydrated gel producing apparatus may comprise one or more suction pumps, a dry gel handling subsystem, and a gel mixer, all of which may be connected by a system of pipes or conduits. According to certain embodiments, the piping system includes a plurality of valves to direct the flow of materials through the apparatus according to the needs or desires of an operator. A person of skill in the art with the benefit of this disclosure will recognize how to adapt known hydrated gel producing apparatus to accommodate a gel hydration tank of the present disclosure. According to another implementation, a hydrated gel producing apparatus of the present disclosure is capable of producing both a gel concentrate as well a finished gel. An example of one hydrated gel producing apparatus into which a gel hydration tank of the present disclosure may be incorporated is the ADP™ Advanced Dry Polymer Blender system (available from Halliburton Energy Services, Inc.).

A liquid, such as water or a pre-gelled liquid, is introduced into a gel mixer from a liquid source (e.g., liquid source 30 shown in FIG. 1) using a suction pump. According to one implementation, the suction pump is a 10×8 Gorman-Rupp pump manufactured by the Gorman-Rupp Company, P.O. Box 1217, Mansfield, Ohio 44901, however, it is within the scope of the disclosure that other pumps may be used. The suction pump and the gel mixer may be powered by a power source, such as that shown in FIG. 2. The liquid may flow through a flowmeter (e.g., a magnetic flowmeter) to determine the flowrate of the liquid introduced into the gel mixer. Dry gel exiting from the outlet of a dry gel handling system may enter the gel mixer through an opening therein. There the dry gel is mixed with the liquid to form a gel concentrate. Although certain apparatus of the present disclosure may be capable of producing both a completed gelled fluid and gel concentrate, production of a gel concentrate, as opposed to a completed gelled fluid, may provide certain advantages. For example, as described below, producing a gel concentrate can enable significantly improving the reaction time between changing the properties of the gel produced and the time delay after which a modified gel is introduced into the well. Other advantages are described below.

The gel mixer agitates and blends the dry gel and liquid. In certain embodiments, the agitating and blending is pre-formed using an impeller as the two components are combined. Consequently, the blending causes a faster, more thorough mixing as well as increases the surface area of the dry gel particles so that the particles are wetted more quickly. Thus, the gel concentrate production time is decreased. Further, certain types of gel mixers are capable of mixing the dry gel and liquid at any rate or ratio. Thus, when producing a gel concentrate, as opposed to a completed or finished gel, a reduced amount of liquid is used and, hence, the gel concentrate is produced more quickly.

The gel concentrate then may be directed through a metering valve to control an amount of gel concentrate exiting the gel mixer, after which other additives optionally may be added to the gel concentrate. Various additives may be introduced to change the chemical or physical properties of the gel concentrate as required, for example, by the geology of the well formation and reservoir. The gel concentrate is then conveyed through a pipe or conduit and into a hydration tank of the present disclosure.

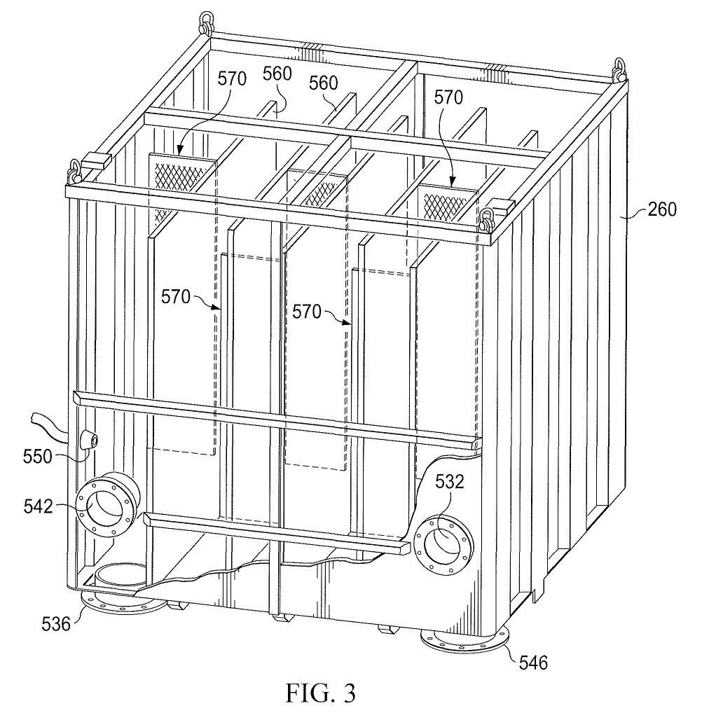

FIG. 3 illustrates the interior structure of a hydration tank 260 of the present disclosure in more detail. The gel concentrate flows into hydration tank 260 through inlet 532 or 542 in order to allow the gel concentrate and/or completed gel to hydrate as it passes through the tank to outlet 536 or 546, respectively. In certain embodiments, one or more suction pumps (not shown) may be coupled in communication with outlet 536 or 546 in order to promote the flow of fluid through the tank and to the outlet. Hydration tank 260 includes an outer body that defines an interior space within the body through which the gel concentrate and/or other fluids may be flowed or stored. In the interior space of the tank 260, a set of over-under weirs 570, which may be aligned with one another across the width of tank 260 as shown, or may be placed at different locations along the length of the tank 260 (e.g., closer or further from the wall of the tanks in which inlets 532 and 542 are located). As a result of the dimensions and placement of the weirs 570, the gel concentrate and/or fluid in tank 260 flowing from one of inlets 532 or 542 to an outlet 536 or 546 on the opposite side of the tank flows in a path over the weirs 570 that extend to the bottom of tank 260 and under the weirs 570 that extend from the top of tank 260 (or at least above the level of the fluid therein). Accordingly, the weirs 570 provide for an extended transient period during which the gel concentrate travels through the hydration tank 260. In the embodiment shown, the interior of the hydration tank 260 also contains a plurality of lateral weirs 560 in a spaced, relatively parallel relationship to further segment the flow between inlet 532 or 542 and outlet 536 or 546. As a result of the shape and placement of the weirs 560, the flow of the gel concentrate through the hydration tank 260 forms a zig-zag or serpentine shape in a horizontal plane as well, providing for a further extended transient period during which the gel concentrate travels through the hydration tank 260.

Also, as a person of ordinary skill in the art with the benefit of this disclosure will recognize, FIG. 3 illustrates only certain types of over-under weirs and lateral weirs that may be used in accordance with the present disclosure. The present disclosure contemplates and includes over-under weirs and lateral weirs of designs that may differ from those shown in FIG. 3. For example, each of the plurality of over-under weirs and lateral weirs may include any number of weirs greater than one. In certain embodiments, the space between each pair of weirs may be increased/decreased from that illustrated in FIG. 3 and, in certain embodiments, may vary across the hydration tank. In certain embodiments, the height of the over-under weirs and/or the length of the lateral weirs (relative to each other and/or the walls of the tank) may be varied. A person of skill in the art with the benefit of this disclosure will be able to recognize and implement design variations of this nature, and such variations are contemplated by the present disclosure and claims.

Hydration tank 260 also includes one or more pneumatic air injection devices 550, which may inject gases (e.g., air) into the tank 260 at certain locations, either continuously or at selected times, to direct and/or facilitate the flow of the gel concentrate in the desired path through the hydration tank 260. In the embodiment shown, the pneumatic air injection device comprises a jetting device (e.g., an air jet) installed on a side wall of the hydration tank 260 through which compressed air may be released (e.g., from an air compressor or container of compressed air) or air may be pumped at pressure into the tank 260 from a tubing or conduit in communication therewith, along with any associated valves and/or air sources. In certain embodiments, pneumatic air injection devices may be installed or placed in any side wall or in the bottom of the hydration tank 260, and any suitable number of such devices may be used. Moreover, the pneumatic air injection device may take on any suitable size, shape, or form for injecting air into the tank. Examples of pneumatic air injection devices that may be suitable in certain embodiments of the present disclosure are the Pulsair® tank mounted mixers, electronic tank mixers, portable tank mixers, and liquid mixing systems available from Pulsair Systems, Inc. In certain embodiments, the injection of air or other gases through the pneumatic air injection device(s) 550 or other pneumatic subsystems may be controlled from the same control station used to control other equipment in the hydrated gel producing apparatus of the present disclosure. In certain embodiments, the injection of air or other gases may occur at certain predetermined time intervals, which may be regulated using any suitable controls, such as a timing circuit.

After passing through the hydration tank 260, the hydrated polymer gel is released from the tank from outlet 536 or 546. Two outlets are provided in the embodiment shown in FIG. 3, although other implementations may include more or fewer outlets. The outlet used to release the hydrated gel may depend upon the location where the gel concentrate entered the hydration tank 260. For example, if the gel concentrate entered the hydration tank through inlet 532, the hydrated gel may be released from outlet 536. Alternatively, if the gel concentrate entered the hydration tank 260 via inlet 542, the hydrated gel may leave the hydration tank 260 through the outlet 546. Hydrated gel leaving hydration tank 260 through outlet 546 may then flow out of the hydrated gel producing apparatus one or more valves and enter a blender apparatus, such as blender apparatus 50 shown in FIG. 1.

An additional advantage of the present disclosure is that the apparatus of the present disclosure is configurable into a “First In/First Out” configuration. Thus, as the hydrated gel is produced, the gel concentrate first to enter the hydration tank 260 is also the first hydrated gel to leave the hydration tank 260 after passing through the path formed by the lateral weirs 560 and over-under weirs 570. As a result, the most hydrated gel is withdrawn from the apparatus 250 first.

While the hydrated gel may be released from the apparatus into the blender apparatus through valves without any flow control, controlling the flow of hydrated gel out of the apparatus may be desirable in some implementations. Accordingly, the hydrated gel producing apparatus of the present disclosure may include an output flow system. The output flow system may include the valves as well as a pump, a flowmeter, and a metering valve. According to one implementation, the pump is a Mission Magnum 8×6 centrifugal pump available from National Oilwell Varco, 10000 Richmond Ave., Houston, Tex. 77042, although the present disclosure is not so limited, and other pumps may be utilized. Additionally, the flowmeters used in the present disclosure may be a number of possible different flow measuring devices, such as a Rosemount magnetic flowmeter available from Rosemount at 8200 Market Blvd., Chanhassen, Minn. 55317, and the metering valves used in the present disclosure may be a number of possible different valves or mechanisms to throttle or meter the flow of the hydrated gel, such as a tub level valve, butterfly valve, or any other type of valve capable of proportional metering control. Similarly, the flowmeters and metering valves are not limited to the examples provided but may be any device operable to measure and control the flowrate of the hydrated gel, respectively. A pump (e.g., pump 690 shown in FIG. 2), flowmeter (e.g., flowmeter 700 shown in FIG. 2), and a metering valve may provide for a constant, specified flowrate of the hydrated gel that can be dynamically changed on the fly, for example, depending on the changing needs of a well fracturing operation. The output system provides for a controlled output of the hydrated gel in which a control unit (e.g., a computerized control unit) (not shown) may monitor the flowrate with an output from the flowmeter. The control unit may then increase or decrease the pumping rate of the pump to maintain a specified flow of the hydrated gel. The hydrated gel then may leave output flow system and exit the apparatus to a blender apparatus.

After leaving the hydrated gel producing apparatus, the hydrated gel (e.g., a hydrated gel concentrate) may be transported to a blender apparatus, such as apparatus 50 in FIG. 1, where it is combined with additional liquid and sand from the liquid source 30 and sand source 40, respectively. The blender apparatus 50 agitates and combines the ingredients to quickly produce a finished or completed gel and sand mixture that is subsequently injected into the well 60. Thus, when the hydrated gel and liquid are blended in the blender apparatus, the combination dilutes quickly to form a finished gel.

The hydrated polymer gels formed using the systems and methods of the present disclosure may be used in any subterranean operation in which gelled treatment fluids may be useful, including but not limited to hydraulic fracturing treatments, acidizing treatments, gravel-packing operations, drilling operations, squeeze treatments, workover treatments, and the like. Such gelled treatment fluids may include, but are not limited to, fracturing fluids, pad fluids, spacer fluids, well bore clean-out fluids, pre-flush fluids, after-flush fluids, gravel packing fluids, drilling fluids or muds, acidizing fluids, cementing fluids, workover fluids, and the like. Thus, as a person of ordinary skill in the art will recognize with the benefit of this disclosure, a system and/or hydration tank of the present disclosure may be installed and/or used at any well site where such treatments may be performed. In some embodiments, the treatment fluid may be introduced at a pressure sufficient to cause at least a portion of the treatment fluid to penetrate at least a portion of the subterranean formation (for example, in fracturing treatments). In other embodiments, the treatment fluid may comprise an acid which may be allowed to interact with the subterranean formation so as to create one or more voids in the subterranean formation (for example, in acidizing treatments). Introduction of the treatment fluid may in some of these embodiments be carried out at or above a pressure sufficient to create or enhance one or more fractures within the subterranean formation (e.g., fracture acidizing). In other embodiments, introduction of the treatment fluid may be carried out at a pressure below that which would create or enhance one or more fractures within the subterranean formation (e.g., matrix acidizing).

The treatment fluids and gel concentrates prepared and/or used in the methods and systems of the present disclosure may comprise any base fluid known in the art, including aqueous base fluids, non-aqueous base fluids, and any combinations thereof. The term “base fluid” refers to the major component of the fluid (as opposed to components dissolved and/or suspended therein), and does not indicate any particular condition or property of that fluid such as its mass, amount, pH, etc. Aqueous fluids that may be suitable for use in the methods and systems of the present disclosure may comprise water from any source. Such aqueous fluids may comprise fresh water, salt water (e.g., water containing one or more salts dissolved therein), brine (e.g., saturated salt water), seawater, or any combination thereof. In most embodiments of the present disclosure, the aqueous fluids comprise one or more ionic species, such as those formed by salts dissolved in water. For example, seawater and/or produced water may comprise a variety of divalent cationic species dissolved therein. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of gelling agents, acids, and other additives included in the fluid. One of ordinary skill in the art, with the benefit of this disclosure, will recognize when such density and/or pH adjustments are appropriate. Examples of non-aqueous base fluids that may be suitable for use in the methods and systems of the present disclosure include, but are not limited to, oils, hydrocarbons, organic liquids, and the like. In certain embodiments, the treatment fluids may comprise a mixture of one or more fluids and/or gases, including but not limited to emulsions, foams, and the like.

The gelling agents used in the methods and systems of the present disclosure may comprise any polymeric material that is capable of increasing the viscosity of an aqueous fluid, for example, by forming a gel. In certain embodiments, the viscosifying agent may viscosify an aqueous fluid when it is hydrated and present at a sufficient concentration. Examples of polymeric gelling agents that may be suitable for use in the present disclosure include, but are not limited to, cellulose and cellulose derivatives (such as hydroxyethyl cellulose, carboxyethylcellulose, carboxymethylcellulose, and carboxymethylhydroxyethylcellulose), guar, guar derivatives (e.g., carboxymethyl guar), biopolymers (e.g., xanthan, scleroglucan, diutan, etc.), clays, modified acrylamides, acrylates, combinations thereof, and derivatives thereof. The term “derivative” is defined herein to include any compound that is made from one of the listed compounds, for example, by replacing one atom in the listed compound with another atom or group of atoms, rearranging two or more atoms in the listed compound, ionizing the listed compounds, or creating a salt of the listed compound. In certain embodiments, the viscosifying agent may be “crosslinked” with a crosslinking agent, among other reasons, to impart enhanced viscosity and/or suspension properties to the fluid. In certain embodiments, such crosslinking may be delayed to a desired time, which may be accomplished by adding a crosslinking agent to the fluid at the time that crosslinking is desired, or adding a delayed crosslinking agent that will become active at the desired time.

The gelling agent may be included in a treatment fluid of the present disclosure in any concentration sufficient to impart the desired viscosity and/or suspension properties to the aqueous fluid. In certain embodiments, the viscosifying agent may be included in a concentration of from about 10 pounds per 1000 gallons (pptg) of the aqueous fluid to about 200 pptg of the aqueous fluid. In certain embodiments, the viscosifying agent may be included in a concentration of from about 10 pptg of the aqueous fluid to about 160 pptg of the aqueous fluid. A person of skill in the art, with the benefit of this disclosure, will recognize the concentration and amount of viscosifying agent to use in a particular embodiment of the present disclosure based on, among other things, the content of the aqueous fluid, the temperature and pH conditions where the treatment fluid will be used, additional additives present in the treatment fluid, and the like.

In certain embodiments, the treatment fluids used in the methods and systems of the present disclosure optionally may comprise any number of additional additives. Examples of such additional additives include, but are not limited to, salts, surfactants, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, H₂S scavengers, CO₂ scavengers, oxygen scavengers, lubricants, additional viscosifiers, breakers, weighting agents, resins, wetting agents, coating enhancement agents, filter cake removal agents, antifreeze agents (e.g., ethylene glycol), and the like. In certain embodiments, one or more of these additional additives (e.g., a crosslinking agent) may be added to the treatment fluid and/or activated after a gelling agent has been at least partially hydrated in the fluid. A person skilled in the art, with the benefit of this disclosure, will recognize the types of additives that may be included in the fluids of the present disclosure for a particular application.

To facilitate a better understanding of the present disclosure, the following examples of certain aspects of preferred embodiments are given. The following examples are not the only examples that could be given according to the present disclosure and are not intended to limit the scope of the disclosure or claims.

### EXAMPLES

### Example 1

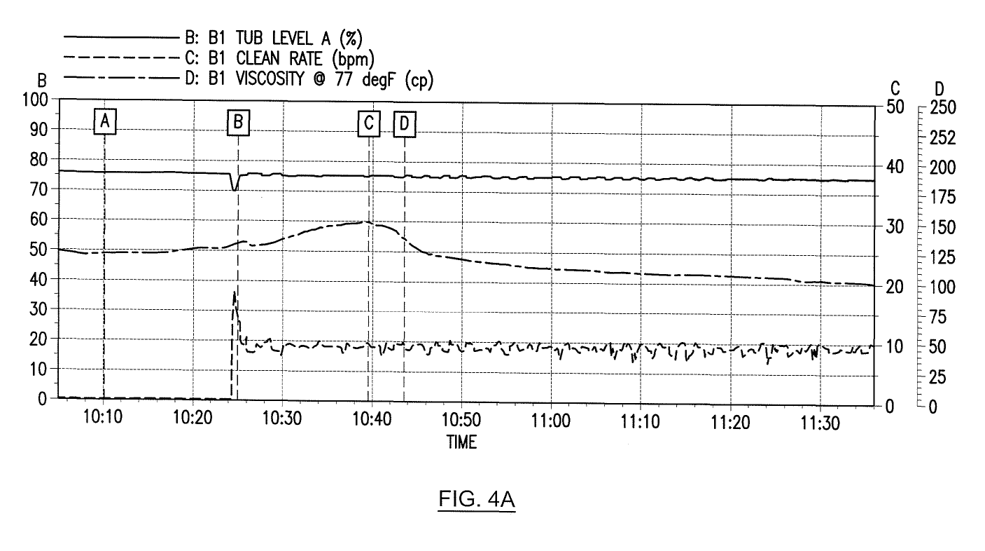

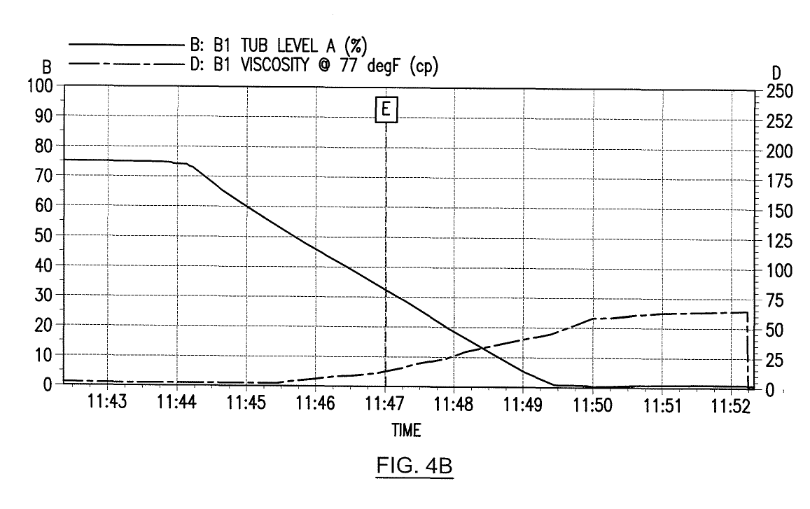

A dry gel hydration tank of a known design equipped with lateral weirs was used to mix an aqueous gel comprising a known amount of WG-36™ guar gelling agent (available from Halliburton Energy Services, Inc.). The tank was set to operate at a 75% tub level, and the hydrated gel was pumped out of the tank at 10 barrels per minute (bpm) with the viscosity of the gel monitored using a viscometer at the fluid discharge point on the pump. FIG. 4A is a plot showing the tub level, pumping rate, and viscosity of the gel during this test. As shown, at time A (10:10:00), the tank was 75% full of an aqueous fluid and gelling agent and then allowed to stand for several minutes. At time B (10:25:00), the pumps were started to pump the hydrated gel out of the tank, and at time C (10:39:29), the viscosity of the gel reached its expected viscosity. This indicates that a layer of thinner gel was on the bottom of the hydration tank. However, at time D (10:45:31), the viscosity of the gel pumped out of the tank began to exhibit an unpredicted decreasing trend that continued until the end of the test.

The data charted in FIG. 4A suggests that the path that the newest partially-hydrated gel took in the tank with only lateral weirs may have been only about 20% to about 30% of the total volume of the tank. This demonstrates the viscous channeling that may occur when a thinner, less hydrated gel resides in or is introduced into the same tank as a thicker, more hydrated gel.

FIG. 4B is a continuation of the plot in FIG. 4A, showing the tub level, pumping rate, and viscosity of the gel later in the test. As shown in FIG. 4B, as the tank was being drained at the end of the testing there was an unexpected spike in viscosity at time E (11:47:00). This confirms that a channel of more viscous gel had been retained in the tank.

### Example 2

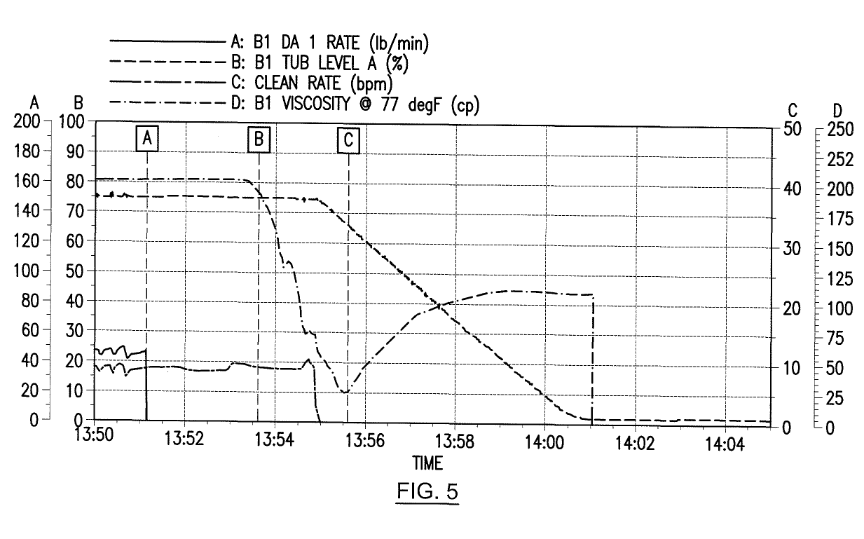

A dry gel hydration tank similar to that used in Example 1 but also equipped with a plurality of “under” weirs (i.e., weirs forcing flow to the bottom of the tank) and a Pulsair® pneumatic liquid mixing apparatus was used to mix an aqueous gel comprising a known amount of WG-36™ guar gelling agent. The tank was set to operate at the same tub level and pump rate, and the viscosity of the gel was monitored in a similar way. FIG. 5 is a plot showing the tub level, pumping rate, and viscosity of the gel during this test. Again, the viscosity of the gel was at its expected viscosity at gelling agent shutoff (time A, 13:51:08), but then began to decrease about 2 minutes and 30 seconds after gelling agent shutoff (time B, 13:53:38). Then, about 1 minute and 22 seconds later (time C, 13:55:36), as the tank level decreased, the viscosity of the gel increased considerably, ending with a viscosity of approximately 110 cP. This data indicates that viscous channeling likely occurred close to the bottom of the hydration (i.e., under the weirs) and the pneumatic liquid mixing apparatus was not able to break up that channel.

### Example 3

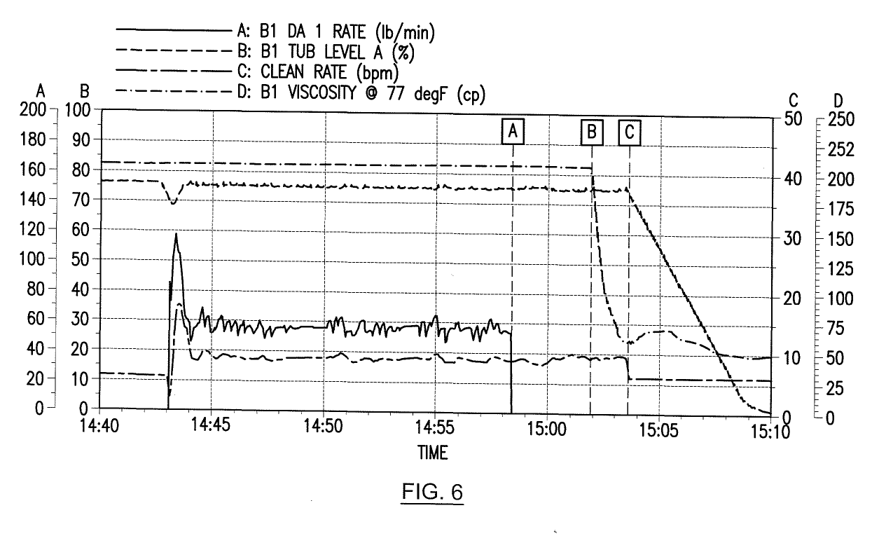

A dry gel hydration tank similar to that used in Example 1 but also equipped with a Pulsair® pneumatic liquid mixing apparatus but with no weirs installed was used to mix an aqueous gel comprising a known amount of WG-36™ guar gelling agent. The tank was set to continuously mix the gel at the same tub level and pump it out of the tank at a rate of 15 bpm, and the viscosity of the gel was monitored in a similar way. FIG. 6 is a plot showing the tub level, pumping rate, and viscosity of the gel during this test. Again, the viscosity of the gel was at its expected viscosity at gelling agent shutoff (time A, 14:58:23), but then began to decrease about 3 minutes and 33 seconds after gelling agent shutoff (time B, 15:01:56). As the tank level decreased (time C, 15:03:35), the viscosity of the gel pumped out of the tank decreased, but did not decrease all the way to zero and instead held to the end of the tank volume at about 50 cP. This indicates that viscous channeling also occurred in this tank, and that the pneumatic liquid mixing apparatus was not able to break up that channel.

### Example 4

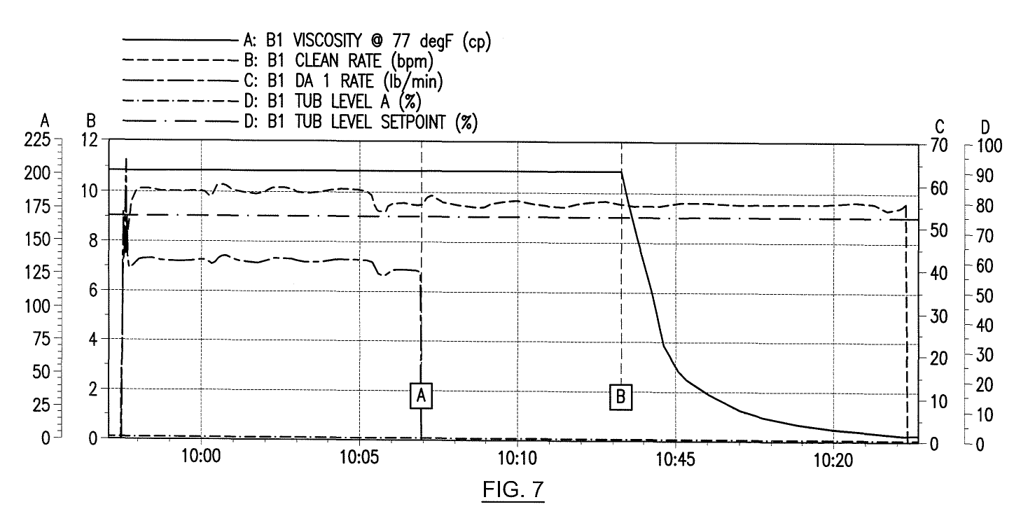

A dry gel hydration tank similar to that used in Example 1 but also equipped with both a plurality of over-under weirs and the pneumatic liquid mixing apparatus of Examples 2 and 3 according to certain embodiments of the present disclosure was used to mix an aqueous gel comprising a known amount of WG-36™ guar gelling agent. The tank was set to operate at the same tub level and pump rate as Example 3, and the viscosity of the gel was monitored in a similar way as the previous examples. The viscosity of the gel remained constant for approximately 5 minutes and 20 seconds after the gelling agent shutoff. FIG. 7 is a plot showing the tub level, pumping rate, and viscosity of the gel during this test. Again, the viscosity of the gel was at its expected viscosity at gelling agent shutoff (time A, 10:07:00), and remained constant for 6 minutes and 15 seconds after gelling agent shutoff (time B, 10:13:15). Based on a calculated residence time of approximately 5 minutes and 42 seconds for the tank for a fluid in this tank (which may be calculated as the total volume of the tank (57 bbl) divided by the pumping rate (10 bpm)), and allowing an appropriate lag time for the viscometer, this indicates that a channel had not formed in the gel in the tank, and maximizes the residence/gelation time of the gel in the tank.

An embodiment of the present disclosure is a method that comprises: a method comprising: combining a polymer gelling agent with an aqueous fluid in a gel hydration unit at a well site to form a hydrated polymer gel, the gel hydration unit comprising: a body defining an interior space; a plurality of over-under weirs installed in the interior space of the gel hydration unit where the hydrated polymer gel is formed, and a pneumatic air injection subsystem that is configured to inject gas into the interior space of the gel hydration unit where the hydrated polymer gel is formed.

Another embodiment of the present disclosure is a gel hydration unit comprising: a body defining an interior space configured to contain a hydrated polymer gel; a plurality of over-under weirs installed in the interior space of the gel hydration unit; and a pneumatic air injection subsystem that is configured to inject gas into the interior space of the gel hydration unit.

Another embodiment of the present disclosure is a method comprising: combining an amount of a polymer gelling agent with an amount of an aqueous base fluid in a gel hydration unit at a well site to form a hydrated polymer gel concentrate, the gel hydration unit comprising: a body defining an interior space; a plurality of over-under weirs installed in the interior space of the gel hydration unit where the hydrated polymer gel concentrate is formed, and a pneumatic air injection subsystem that is configured to inject gases into the interior space of the gel hydration unit where the hydrated polymer gel concentrate is formed; combining the hydrated polymer gel concentrate with a base fluid to form a gelled fracturing fluid; and introducing the gelled fracturing fluid into at least a portion of a subterranean formation at or above a pressure sufficient to create or enhance at least one fracture in the subterranean formation.

Therefore, the present disclosure is well-adapted to carry out the objects and attain the ends and advantages mentioned as well as those which are inherent therein. While the disclosure has been depicted and described by reference to exemplary embodiments of the disclosure, such a reference does not imply a limitation on the disclosure, and no such limitation is to be inferred. The disclosure is capable of considerable modification, alteration, and equivalents in form and function, as will occur to those ordinarily skilled in the pertinent arts and having the benefit of this disclosure. The depicted and described embodiments of the disclosure are exemplary only, and are not exhaustive of the scope of the disclosure. The terms in the claims have their plain, ordinary meaning unless otherwise explicitly and clearly defined by the patentee.

What is claimed is:

1. A method comprising:
combining a polymer gelling agent with an aqueous fluid in a gel hydration unit at a well site to form a hydrated polymer gel, the gel hydration unit comprising:
a body defining an interior space;
a plurality of over-under weirs installed in the interior space of the gel hydration unit where the hydrated polymer gel is formed, and
a pneumatic air injection subsystem that is configured to inject gas into the interior space of the gel hydration unit where the hydrated polymer gel is formed.

2. The method of claim 1 wherein the hydrated polymer gel comprises a hydrated polymer gel concentrate, and the method further comprises combining the hydrated polymer gel concentrate with a base fluid to form a gelled fluid.

3. The method of claim 2 further comprising introducing the gelled fluid into at least a portion of a subterranean formation.

4. The method of claim 3 wherein the gel hydration unit is located at a well site comprising a well bore that penetrates at least a portion of the subterranean formation.

5. The method of claim 1 wherein the gel hydration unit further comprises a plurality of lateral weirs installed in the interior space of the gel hydration unit where the hydrated polymer gel is formed.

6. The method of claim 1 wherein the pneumatic air injection subsystem further comprises one or more jetting devices installed on the body that are connected to a source of compressed gas.

7. The method of claim 6 wherein the pneumatic air injection subsystem further comprises a timing circuit that controls the injection of gas into the interior space of the gel hydration unit.

8. The method of claim 1 wherein combining the polymer gelling agent with the aqueous fluid comprises pumping a polymer gel concentrate comprising the polymer gelling agent into the gel hydration unit.

9. The method of claim 8 wherein:
the polymer gel concentrate is pumped into the gel hydration unit at a first pumping rate; and
a residence time for the hydrated polymer gel in the gel hydration unit is at least about 90% of an expected residence time for the hydrated polymer gel in the gel hydration unit.

10. A gel hydration unit comprising:
a body defining an interior space configured to contain a hydrated polymer gel;
a plurality of over-under weirs installed in the interior space of the gel hydration unit; and
a pneumatic air injection subsystem that is configured to inject gas into the interior space of the gel hydration unit.

11. The gel hydration unit of claim 10 wherein the gel hydration unit is located at a well site comprising a well bore that penetrates at least a portion of a subterranean formation.

12. The gel hydration unit of claim 10 wherein further comprising a plurality of lateral weirs installed in the interior space of the gel hydration unit.

13. The gel hydration unit of claim 10 wherein the pneumatic air injection subsystem further comprises one or more jetting devices installed on the body that are connected to a source of compressed gas.

14. The gel hydration unit of claim 13 wherein the pneumatic air injection subsystem further comprises a timing circuit that controls injection of gas into the interior space of the gel hydration unit.

15. A method comprising:
combining an amount of a polymer gelling agent with an amount of an aqueous base fluid in a gel hydration unit at a well site to form a hydrated polymer gel concentrate, the gel hydration unit comprising:
a body defining an interior space;
a plurality of over-under weirs installed in the interior space of the gel hydration unit where the hydrated polymer gel concentrate is formed, and
a pneumatic air injection subsystem that is configured to inject gases into the interior space of the gel hydration unit where the hydrated polymer gel concentrate is formed;
combining the hydrated polymer gel concentrate with a base fluid to form a gelled fracturing fluid; and
introducing the gelled fracturing fluid into at least a portion of a subterranean formation at or above a pressure sufficient to create or enhance at least one fracture in the subterranean formation.

16. The method of claim 15 wherein combining the polymer gelling agent with the aqueous fluid comprises pumping a polymer gel concentrate comprising the polymer gelling agent into the gel hydration unit.

17. The method of claim 16 wherein:
the polymer gel concentrate is pumped into the gel hydration unit at a first pumping rate; and
a residence time for the hydrated polymer gel concentrate in the gel hydration unit is at least about 90% of an expected residence time for the hydrated polymer gel concentrate in the gel hydration unit.

18. The method of claim 15 wherein the pneumatic air injection subsystem further comprises one or more jetting devices installed on the body that are connected to a source of compressed gas.

19. The method of claim 15 wherein the pneumatic air injection subsystem further comprises a timing circuit that controls injection of gas into the interior space of the gel hydration unit.

20. The method of claim 15 wherein the gel hydration unit further comprises a plurality of lateral weirs installed in the interior space of the gel hydration unit where the hydrated polymer gel concentrate is formed.
